(19) United States
(12) Patent Application Publication
(10) Pub. No.: US 2015/0027221 A1
(43) Pub. Date: Jan. 29, 2015

(54) THERMAL FLOWMETER

(71) Applicant: Tem-Tech Lab. Co., Ltd., Tokyo (JP)

(72) Inventors: Mitsuyoshi AIZAWA, Tokyo (JP); Hideki NARITA, Tokyo (JP)

(73) Assignee: Tem-Tech Lab. Co., Ltd., Tokyo (JP)

(21) Appl. No.: 14/066,827

(22) Filed: Oct. 30, 2013

(30) Foreign Application Priority Data
Jul. 23, 2013 (JP) 2013-152922

(51) Int. Cl. G01F 1/688

(52) U.S. Cl. CPC G01F 1/688
USPC 73/204.23

(57) ABSTRACT

A highly reliable, simple-structured and low-cost thermal flowmeter is provided. The thermal flowmeter in an embodiment according to the present invention includes a planar heating element located to surround a part of an outer side surface of a flow path; first and second temperature detection elements located on the planar heating element at a prescribed interval; and electrodes located at both of two ends of the planar heating element. The planar heating element contains a carbon material and cellulose fiber.

### CROSS-REFERENCE TO RELATED APPLICATIONS

This application is based upon and claims the benefit of priority from the prior Japanese Patent Application No. 2013-152922, filed on Jul. 23, 2013, the entire contents of which are incorporated herein by reference.

### FIELD

The present invention relates to a flowmeter, and specifically to a thermal flowmeter including a heating element.

### BACKGROUND

A conventional thermal flowmeter has a structure by which a flow of a fluid in a flow path is divided into a main flow and a bypass flow, and the flow velocity of the bypass flow is measured to calculate the flow rate of the entire fluid (see, for example, Patent Document 1: “Japanese Laid-Open Patent Publication No. 2001-259039”).

FIG. 10 shows a schematic structure of a conventional thermal flowmeter including a thin pipe branched from a flow path pipe. In this structure, the flow rate is measured based on the flow velocity of a bypass flow in the thin pipe. The thermal flowmeter shown in FIG. 10 has the following structure. A heater (heating resistor) 310 is wound around a thin pipe 313 in which a bypass flow Y flows. Temperature sensors (temperature resisting elements) 311a and 311b are located at an upstream position and a downstream position of the fluid while having the heater 310 therebetween.

Such a conventional thermal flowmeter works as follows. When no fluid flows, the heat of the heater 310 is transmitted to both of the temperature sensors 311a and 311b uniformly, and thus signals output from the temperature sensors 311a and 311b are well balanced. By contrast, when a fluid flows, the balance between the signal output from the upstream temperature sensor 311a and the signal output from the downstream temperature sensor 311b is broken. The degree of change in the output signals is in proportion to the flow velocity. Utilizing this, the flow rate of the fluid is calculated.

As shown in FIG. 10, an example of such a conventional thermal flowmeter has the following structure. Flow elements 315 formed of, for example, a plurality of metal plates having thin holes, a plurality of thin metal pipes or the like are provided in a main flow path 314 in which a main flow X flows. An appropriate resistance is given to a flow F to determine the ratio of the flow velocity of the bypass flow Y with respect to the flow velocity of the main flow X. In the conventional thermal flowmeter shown in FIG. 10, the flow velocity of the main flow X and the flow velocity of the bypass flow Y increase or decrease at a certain ratio owing to the elements 315. Therefore, the flow rate of the entire flow can be calculated by measuring the flow velocity of the bypass flow Y.

Another conventional thermal flowmeter, unlike the thermal flowmeter shown in FIG. 10, does not include the thin pipe 313 branched from the flow path pipe, but includes a heater and a temperature sensor in the flow path pipe and thus measures the flow rate (see, for example, Patent Document 2: “Japanese Laid-Open Patent Publication No. 2005-055317”).

In the case of the thermal flowmeter described in Patent Document 1, which has a structure in which the flow velocity of the bypass flow in the thin pipe 313 branched from the flow path pipe is measured, a high precision is required for producing the thin pipe 313 and the flow elements 315. This complicates the production process, which causes an undesirable possibility that the production cost is raised.

In the case of the thermal flowmeter described in Patent Document 2, which has a structure in which the heater and the detector are provided in the flow path pipe, there is an undesirable possibility that these elements in the flow path pipe block the flow path or cause pressure loss.

In the structure of the conventional thermal flowmeter shown in FIG. 10, the heater 310 is a coil formed of a metallic heating wire wound around the thin pipe 313. It may be difficult to form the metal wire into such a coiled shape depending on the shape of the flow path pipe, and there is an undesirable possibility that the metal wire is broken or the heater cannot heat the fluid uniformly.

The present invention for solving such problems of the conventional structures has an object of providing a highly reliable, simple-structured and low-cost thermal flowmeter which does not have a complicated structure in a flow path pipe but has a structure of heating a fluid by use of a planar heating element to realize stable measurement of the flow rate.

### SUMMARY

A thermal flowmeter in an embodiment according to the present invention includes a planar heating element located to surround a part of an outer side surface of a flow path; first and second temperature detection elements located on the planar heating element at a prescribed interval; and electrodes located at both of two ends of the planar heating element. The planar heating element contains a carbon material and cellulose fiber.

In a thermal flowmeter in an embodiment according to the present invention, the carbon material may be carbon nanotube or carbon black.

In a thermal flowmeter in an embodiment according to the present invention, a flow rate of a fluid flowing in the flow path may be calculated based on a signal corresponding to a temperature difference between a temperature detected by the first temperature detection element and a temperature detected by the second temperature detection element.

A thermal flowmeter in an embodiment according to the present invention may further include a correction circuit for correcting the signal corresponding to the temperature difference to calculate the flow rate of the fluid.

In a thermal flowmeter in an embodiment according to the present invention, the planar heating element may be bonded to the outer side surface of the flow path by an adhesive.

The present invention can provide a thermal flowmeter which does not include a complicated structure in the flow path pipe but has a structure of heating the fluid by use of a planar heating element to realize stable measurement of the flow rate, is highly reliable, has a simple structure, and costs low.

### BRIEF DESCRIPTION OF DRAWINGS

FIG. 1 is an isometric view showing a schematic structure of a thermal flowmeter in an embodiment according to the present invention;

FIG. 2 is a cross-sectional view showing an example of structure of the thermal flowmeter shown in FIG. 1;

FIG. 3 shows an example of structure of a flow rate detection circuit included in the thermal flowmeter in an embodiment according to the present invention;

FIG. 4 is a view provided to explain the example of structure of the flow rate detection circuit shown in FIG. 3;

FIG. 5 shows views provided to explain an operating principle of the thermal flowmeter in an embodiment according to the present invention;

FIG. 6 shows views provided to explain an operating principle of the thermal flowmeter in an embodiment according to the present invention;

FIG. 7 shows an example of structure of a flow rate detection circuit included in the thermal flowmeter in an embodiment according to the present invention;

FIG. 8 shows an example of structure of a thermal flowmeter in an embodiment according to the present invention;

FIG. 9 shows an example of structure of a thermal flowmeter in an embodiment according to the present invention; and

FIG. 10 shows a schematic structure of a conventional thermal flowmeter.

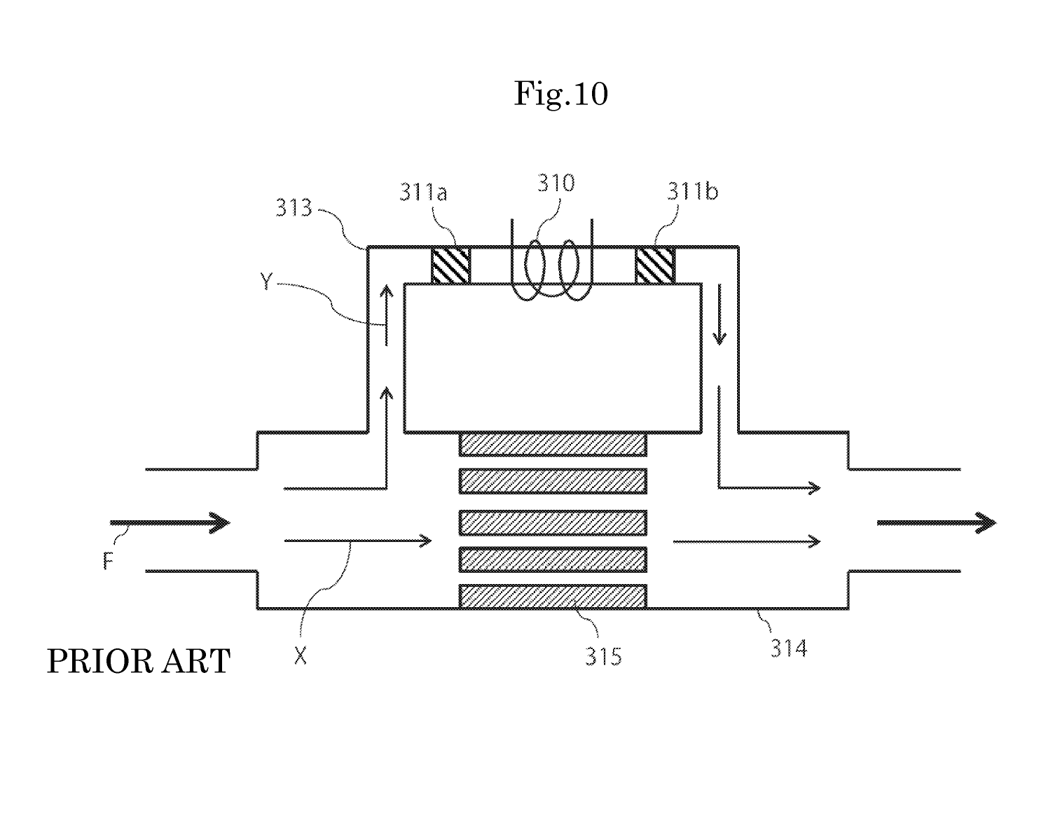

### DESCRIPTION OF EMBODIMENTS

Hereinafter, an embodiment according to the present invention will be described in detail with reference to the drawings. The present invention is not limited to the following embodiment, and may be carried out in any of various forms without departing from the gist thereof.

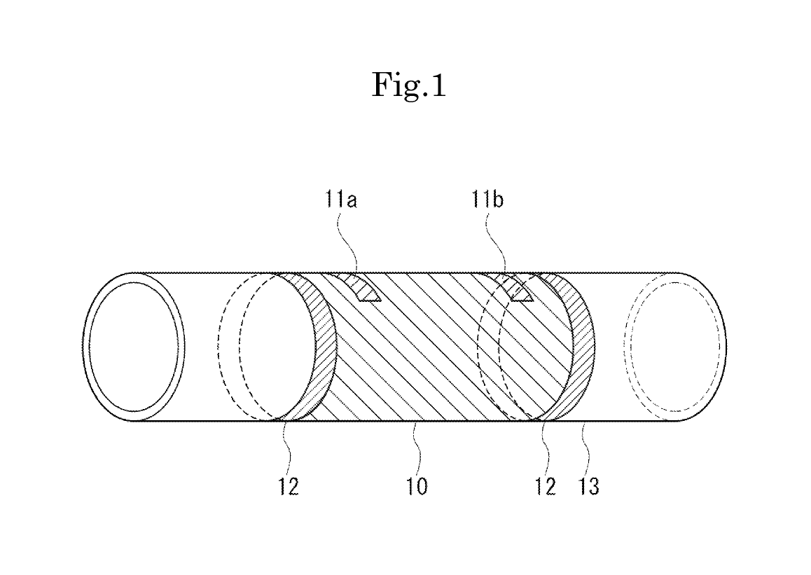

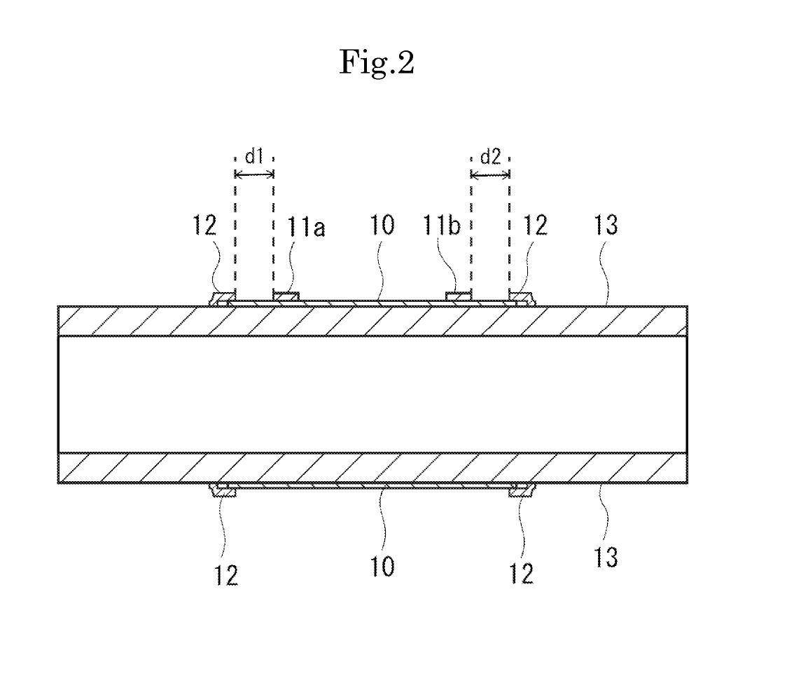

With reference to FIG. 1 and FIG. 2, a basic structure of a thermal flowmeter in an embodiment according to the present invention will be described. FIG. 1 is an isometric view showing a schematic structure of a thermal flowmeter in an embodiment according to the present invention. FIG. 2 is a cross-sectional view showing an example of structure of the thermal flowmeter shown in FIG. 1.

As shown in FIG. 1, the thermal flowmeter in an embodiment according to the present invention includes a planar heating element 10 located to surround a part of an outer side surface of a flow path 13 in which a fluid flows, a first temperature detection element 11a and a second temperature detection element 11b located on the planar heating element 10 at a prescribed interval, and electrodes 12 located at both of two ends of the planar heating element 10. In this embodiment, the planar heating element 10 is a sheet-like heating element containing a carbon material and cellulose fiber, and is flexible enough to be along the shape of the outer side surface of the flow path 13 easily.

The carbon material contained in the planar heating element 10 may be, for example, carbon nanotube (CNT). Such a planar heating element 10 may be a carbon nanotube paper (sheet) formed of a mixture of carbon nanotube and cellulose fiber such as pulp or the like. Carbon nanotube is highly bindable with cellulose fiber. Therefore, the planar heating element 10 containing carbon nanotube as the carbon material has a high rupture strength, a high tensile strength and a high durability. The planar heating element 10 containing carbon nanotube has a higher current density than a heating element formed of a metal wire, and therefore has a high electric conductivity, a high thermal conductivity, and a good heat distribution. The carbon nanotube may be single wall nanotube (SWNT), double wall nanotube (DWNT), or multi-wall nanotube (MWNT).

Alternatively, the carbon material contained in the planar heating element 10 may be carbon black. The heating element 10 containing carbon black as the carbon material also has a high durability, a high electric conductivity, a high thermal conductivity, and a good heating distribution, like the planar heating element 10 containing carbon nanotube. Carbon black may be, for example, thermal black, furnace black, lamp black, channel black, acetylene black or the like.

The planar heating element 10 formed by use of such a carbon material can be easily bonded on the outer side surface of the flow path 13 along the shape thereof by use of an existing adhesive. As can be seen, the planar heating element 10 in an embodiment according to the present invention can be fixed along the outer side surface of the flow path 13 by a simple production process regardless of the shape of the flow path 13. Therefore, in the case where, for example, the flow path 13 is cylindrical as shown in FIG. 1, the planar heating element 10 may be cylindrical. Alternatively, the planar heating element 10 may have any of various shapes in accordance with the shape of the flow path 13.

The planar heating element 10 in an embodiment according to the present invention can be located to cover the outer side surface of the flow path 13 uniformly, and therefore can heat the fluid flowing in the flow path 13 uniformly. Namely, the planar heating element 10 surrounding the flow path 13 is in contact with any position of the outer side surface of the flow path 13, and can generate heat in a planar heating distribution with no lopsidedness on the outer side surface of the flow path 13. Therefore, the planar heating element 10 can heat the entirety of the fluid flowing in the flow path 13 with no lopsidedness. Thus, even when, for example, a liquid-like fluid containing air bubbles flows in the flow path 13, the planar heating element 10 can heat the entirety of the fluid with no lopsidedness.

As described above, the planar heating element 10 in an embodiment according to the present invention has a structure providing a high thermal conductivity and also provides a high heating efficiency, and therefore can realize low power consumption. In addition, the planar heating element 10 in an embodiment according to the present invention can be produced by a simple production process and at lower cost than a heating element formed of a metal wire.

FIG. 2 shows a structure in which the electrodes 12 are located at positions covering both of two ends of the planar heating element 10 located on the outer side surface of the flow path 13. In this structure, the flow path 13 is formed of an insulating material. Alternatively, the flow path 13 may be a metal pipe, in which case, an insulating layer is provided between the flow path 13 and the planar heating element 10.

The electrodes 12 may each be sheet-like and long enough to surround the flow path 13, like the planar heating element 10. For example, the electrodes 12 may each be a copper electrode formed of a copper tape. The electrodes 12 are connected to the planar heating element 10 at both of two ends thereof, and are connected to a power source for supplying an electric current for causing the planar heating element 10 to generate heat. The electrodes 12 may be bonded and fixed to the planar heating element 10 by use of a conductive adhesive.

As shown in FIG. 1 and FIG. 2, the first temperature detection element 11a and the second temperature detection element 11b are located at a prescribed interval on the planar heating element 10. As shown in FIG. 2, distance d1 from the first temperature detection element 11a to the corresponding electrode 12 and distance d2 from the second temperature detection element 11b to the corresponding electrode 12 are equal to each other. By setting the distance d1 and distance d2 to be equal to each other, the first and second temperature detection elements 11a and 11b can be located at such positions that the heat from the planar heating element 10 is transmitted uniformly thereto. This decreases an error between the potential detected by the first temperature detection element 11a and the potential detected by the second temperature detection element 11b.

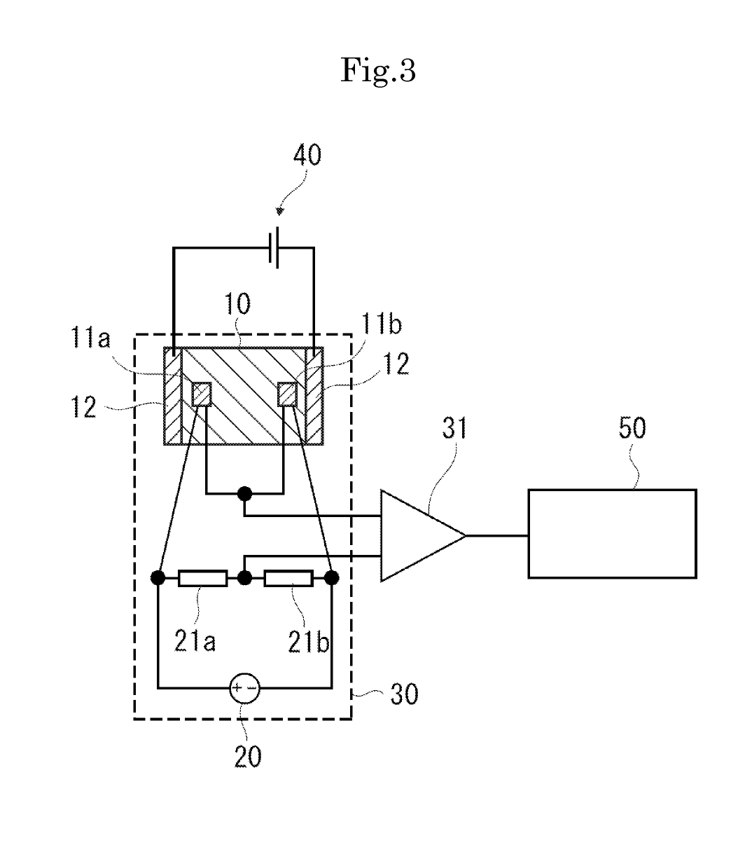

The thermal flowmeter having such a structure includes a flow rate detection circuit including the first and second temperature detection elements 11a and 11b. Hereinafter, with reference to FIG. 3 through FIG. 6, a structure and an operation of the flow rate detection circuit included in the thermal flowmeter in an embodiment according to the present invention will be described.

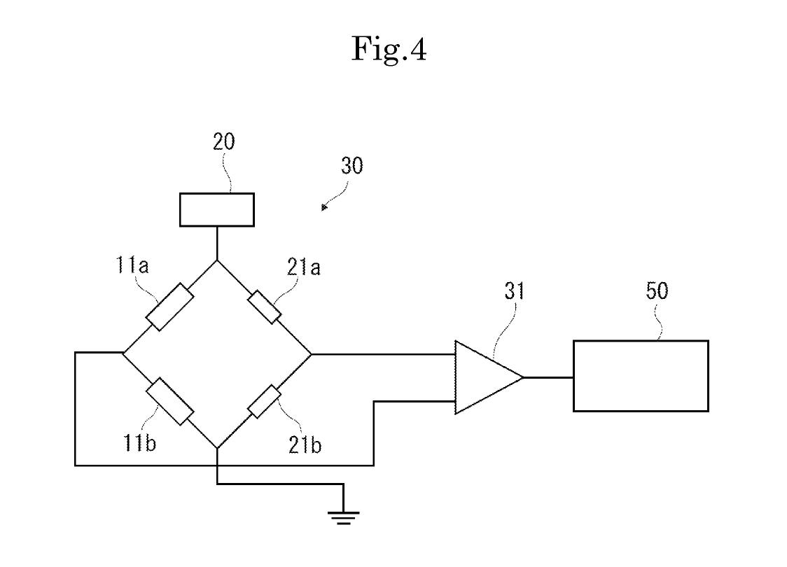

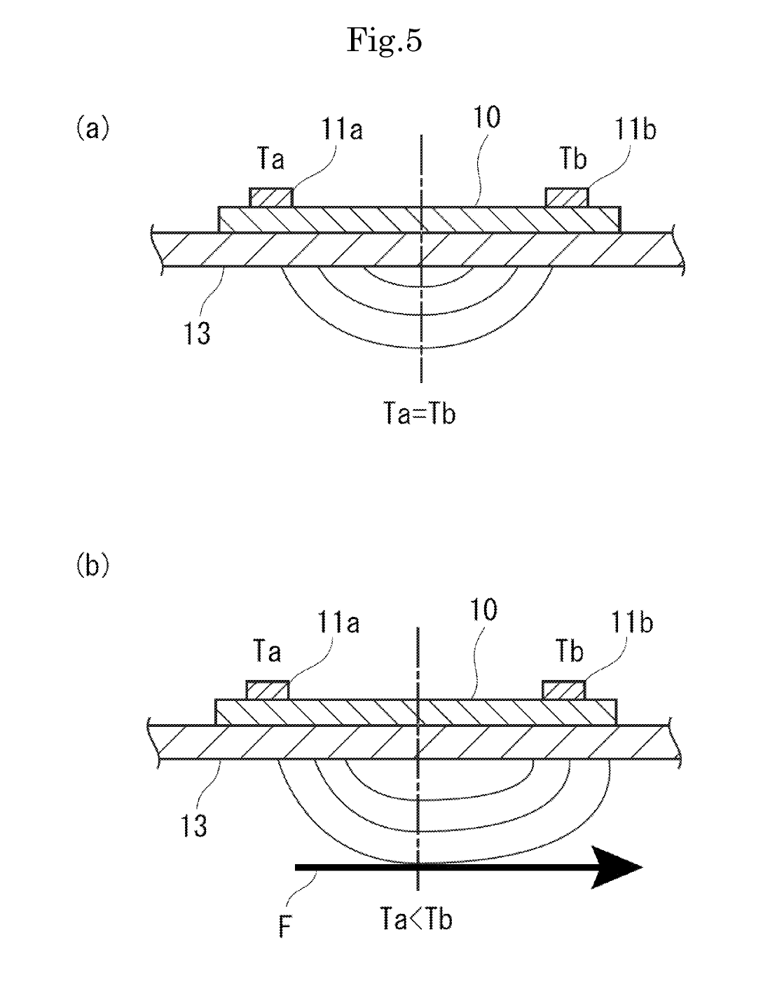

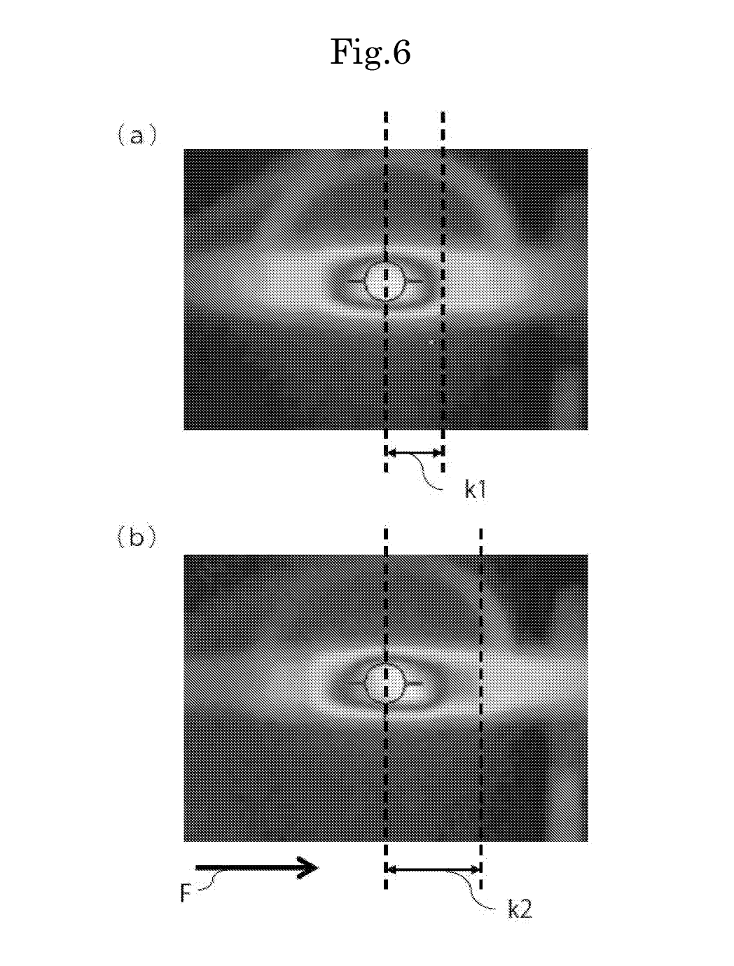

FIG. 3 shows an example of structure of the flow rate detection circuit included in the thermal flowmeter in an embodiment according to the present invention. FIG. 4 is a view provided to explain the example of structure of the flow rate detection circuit shown in FIG. 3. FIG. 5 and FIG. 6 show views provided to explain an operating principle of the thermal flowmeter in an embodiment according to the present invention.

As shown in FIG. 3 and FIG. 4, the flow rate detection circuit included in the thermal flowmeter in an embodiment according to the present invention includes a bridge circuit 30 including the first temperature detection element 11a and the second temperature detection element 11b, and an amplifier circuit 31 for performing a computation on a signal output from the bridge circuit 30. As shown in FIG. 3, the planar heating element 10 on which the first temperature detection element 11a and the second temperature detection element 11b are located at a prescribed interval has the electrodes 12 located at both of two ends thereof, and is connected to a power source 40 via the electrodes 12.

As shown in FIG. 3 and FIG. 4, the bridge circuit 30 has a structure in which four resistors including the first temperature detection element 11a, the second temperature detection element 11b, a third resistor 21a and a fourth resistor 21b are connected to a power source 20. The first temperature detection element 11a and the second temperature detection element 11b may each include, for example, a platinum resistor. The bridge circuit 30 is in an equilibrium state when no fluid flows in the flow path 13. When a fluid flows in the flow path 13, the equilibrium state of the bridge circuit 30 is broken and the bridge circuit 30 provides an output signal. The signal output from the bridge circuit 30 passes the amplifier circuit 31, and then is corrected by a correction circuit 50. Thus, a signal corresponding to the flow rate is retrieved.

Hereinafter, with reference to FIG. 5 and FIG. 6, the operating principle of the flow rate detection circuit will be described in more detail. FIG. 5(a) is a conceptual view showing a temperature distribution when no fluid flows. FIG. 5(b) is a conceptual view showing a temperature distribution when a fluid flows. FIG. 6(a) is a thermographic image showing a temperature distribution when no fluid flows. FIG. 6(b) is a thermographic image showing a temperature distribution when a fluid flows. In FIG. 5(a) and FIG. 5(b), Ta represents the temperature detected by the first temperature detection element 11a, and Tb represents the temperature detected by the second temperature detection element 11b.

An electric current is supplied from the power source 40, and thus the planar heating element 10 generates heat. Then, when no fluid flows as shown in FIG. 5(a), the heat of the planar heating element 10 is uniformly transmitted to the first and second temperature detection elements 11a and 11b located at both of two ends of the planar heating element 10. At this point, the temperature Ta detected by the first temperature detection element 11a and the temperature Tb detected by the second temperature detection element 11b are in an equilibrium state. In the bridge circuit 30, the resistance value of the first temperature detection element 11a and the resistance value of the second temperature detection element 11b are in an equilibrium state. Therefore, no signal is output from the bridge circuit 30.

By contrast, when a fluid flows in a direction F shown in FIG. 5(b) and FIG. 6(b), the fluid flows in the flow path 13 while taking the heat of the planar heating element 10. Namely, the heat generated on the upstream side is moved downstream, namely, in the direction F. As a result, while the fluid is flowing, the temperature Tb detected by the second temperature detection element 11b located on the downstream side becomes higher than the temperature Ta detected by the first temperature detection element 11a located on the upstream side. The temperature distribution shown in FIG. 6(b) while the fluid is flowing is different as follows from the temperature distribution shown in FIG. 6(a) while no fluid is flowing. A high temperature range represented by k1 in FIG. 6(a) expands to a wider range represented by k2 in FIG. 6(b). It can be seen that the heat is propagated downstream along with the movement of the fluid.

As can be seen, the temperature Ta detected by the first temperature detection element 11a and the temperature Tb detected by the second temperature detection element 11b are changed along with the movement of the fluid. Therefore, in the bridge circuit 30, the equilibrium state between the resistance value of the first temperature detection element 11a and the resistance value of the second temperature detection element 11b is broken. Thus, the bridge circuit 30 outputs a signal.

The signal which is output from the bridge circuit 30 at this point corresponds to a temperature difference between the temperature detected by the first temperature detection element 11a and the temperature detected by the second temperature detection element 11b, and is changed in accordance with the change in the resistance value of the first temperature detection element 11a and the resistance value of the second temperature detection element 11b. The flow velocity of the fluid is changed in proportion to the temperature difference between the temperature detected by the first temperature detection element 11a and the temperature detected by the second temperature detection element 11b. Therefore, the flow rate detection circuit included in the thermal flowmeter in an embodiment according to the present invention can calculate the flow rate of the fluid based on the signal output from the bridge circuit 30.

The signal output from the bridge circuit 30 is input to, and computed by, the amplifier circuit 31, and then is input to the correction circuit 50. The correction circuit 50 performs a correction on the signal output from the amplifier circuit 31 and outputs a signal corresponding to the flow rate of the fluid. The correction circuit 50 may hold, in advance, a correction coefficient calculated based on a measured value, and correct the signal output from the amplifier circuit 31 by use of the correction coefficient. The flow velocity of the fluid is changed in proportion to the temperature difference between the temperatures detected by the first and second temperature detection elements 11a and 11b, but the change is not in complete linear proportion. Therefore, the correction circuit 50 makes a correction by use of the correction coefficient, so that a value closer to an accurate flow rate can be found.

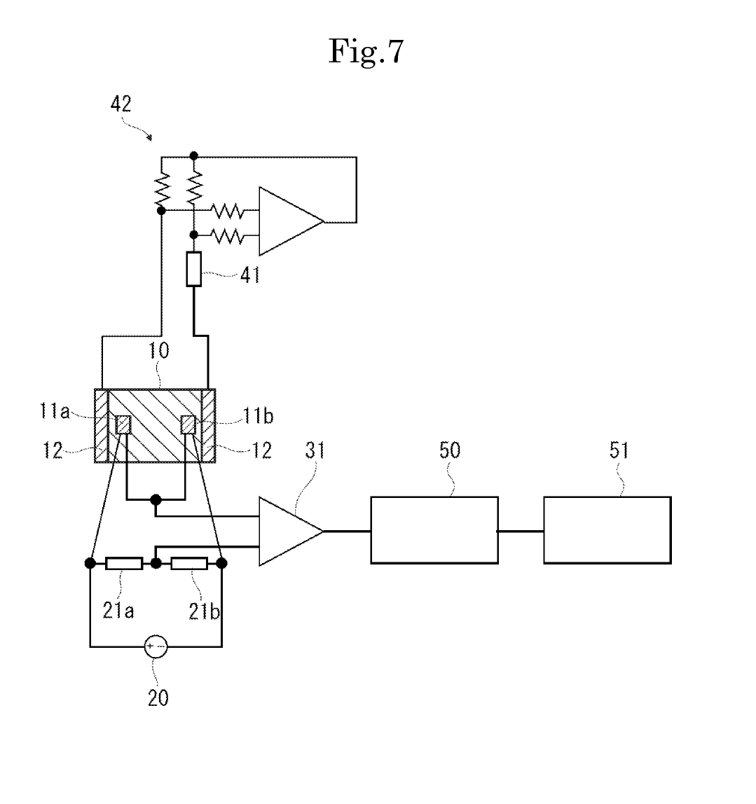

A structure of a thermal flowmeter including such a flow rate detection circuit will be further described with reference to FIG. 7. FIG. 7 shows an example of structure of a flow rate detection circuit included in the thermal flowmeter in an embodiment according to the present invention. As shown in FIG. 7, the signal output from the correction circuit 50 may be input to a display section 51. The signal output from the correction circuit 50 may be processed by the display section 51, and the flow rate of the fluid may be displayed on the display section 51.

As shown in FIG. 7, the planar heating element 10 may be connected, via the electrodes 12, to a heating power supply circuit 42 including an ambient temperature detection element 41. Provision of the heating power supply circuit 42 allows the ambient temperature of the planar heating element 10 to be detected by the ambient temperature detection element 41. Therefore, the temperature of the planar heating element 10 can be made controllable based on the detected ambient temperature of the planar heating element 10. In this manner, the temperature of the planar heating element 10 is controlled by the heating power supply circuit 42 so as not to exceed a prescribed temperature range, and thus the flow rate detection precision of the thermal flowmeter can be improved.

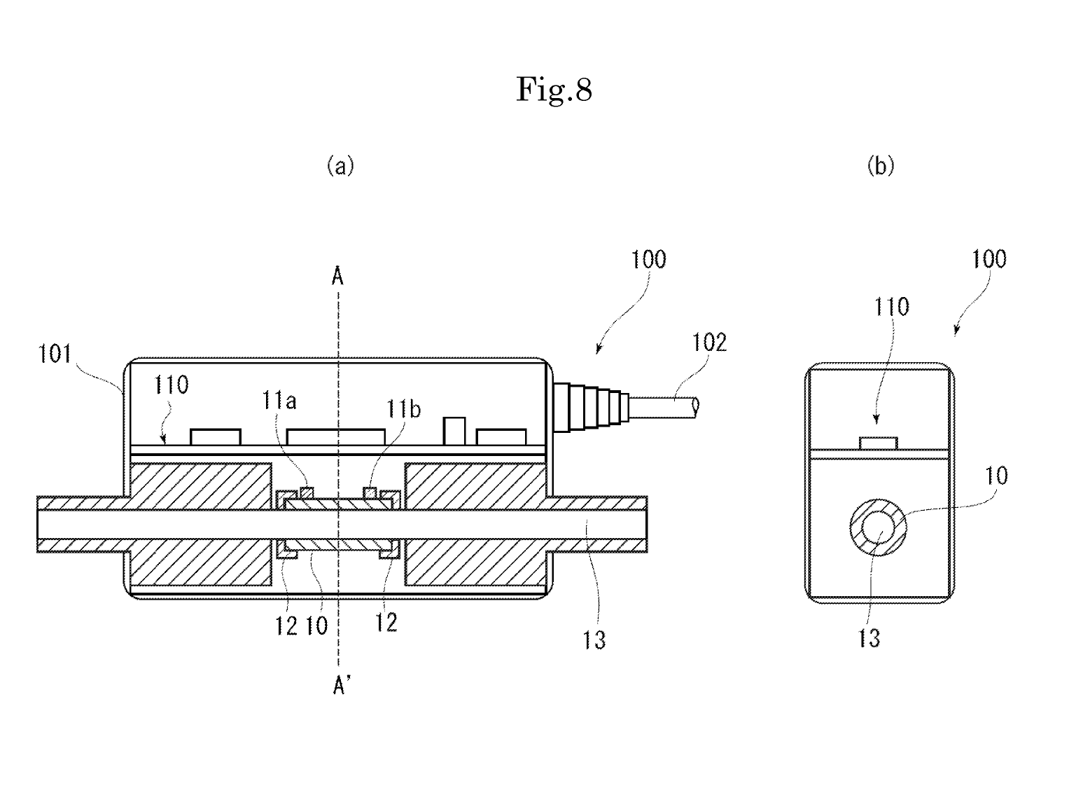

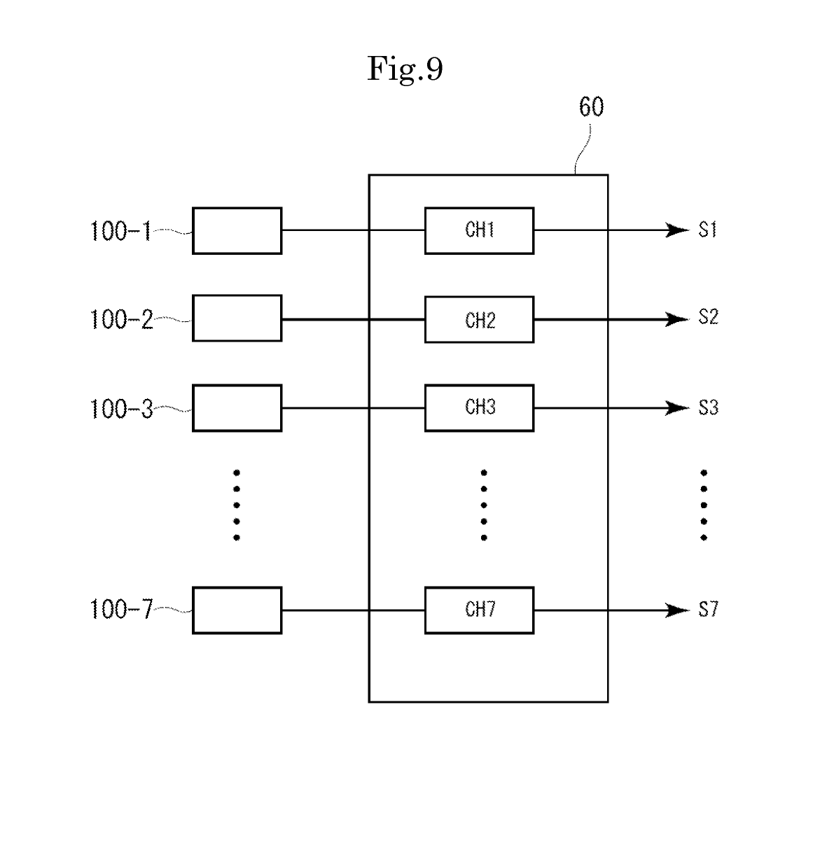

An example of structure of a thermal flowmeter in an embodiment according to the present invention having such a structure will be described with reference to FIG. 8 and FIG. 9. FIG. 8 and FIG. 9 each show an example of structure of a thermal flowmeter 100 in an embodiment according to the present invention.

FIG. 8(a) shows a schematic cross-sectional structure of a thermal flowmeter 100, and FIG. 8(b) shows a cross-sectional structure taken along line A-A′ in FIG. 8(a). As shown in FIG. 8(a), the thermal flowmeter 100 in an embodiment according to the present invention includes the planar heating element 10 and the electrodes 12 provided on the outer side surface of the flow path 13, which is fixed in a housing 101. On the planar heating element 10, the first temperature detection element 11a and the second temperature detection element 11b are located at a prescribed interval.

Although not shown in FIG. 8(a), the flow rate detection circuit described above with reference to FIG. 3 and FIG. 4 may be formed on an electronic circuit substrate 110 shown in FIG. 8(a). In this case, the bridge circuit 30, the amplifier circuit 31 and the correction circuit 50 may each be formed on the electronic circuit substrate 110. Although not shown in FIG. 8(a), the third resistor 21a and the fourth resistor 21b, which are formed on the electronic circuit substrate 110, may be connected to the first temperature detection element 11a and the second temperature detection element 11b via wires to form the bridge circuit 30. The power source 40 for supplying an electric current for causing the planar heating element 10 to generate heat and the heating power supply circuit 42 may each be formed on the electronic circuit substrate 110.

In the thermal flowmeter 100 shown in FIG. 8(a), a signal output from the flow rate detection circuit is output from an output terminal 102. The output signal may be, for example, input to an abnormal flow rate detecting electronic circuit CH1 shown in FIG. 9. FIG. 9 shows a schematic structure of a thermal flowmeter in an embodiment according to the present invention. The thermal flowmeter shown in FIG. 9 is a multi-channel thermal flowmeter including a thermal flowmeter in an embodiment according to the present invention for each of a plurality of flow paths. As shown in FIG. 9, signals output from the plurality of thermal flowmeters 100-1 through 100-7 may be respectively input to a plurality of abnormal flow rate detecting electronic circuits CH1 through CH7 formed on an abnormal flow rate detecting electronic circuit board 60, so that abnormality of the flow rate(s) is detected.

The abnormal flow rate detecting electronic circuits CH1 through CH7 shown in FIG. 9 respectively calculate flow rates based on, for example, signals corresponding to the flow rates which are output from the plurality of thermal flowmeters 100-1 through 100-7, and compare the calculated flow rates against a prescribed threshold to determine whether or not the flow rates exceed the prescribed threshold. When the calculated flow rates are smaller or larger than the prescribed threshold, the abnormal flow rate detecting electronic circuits CH1 through CH7 may respectively output flow rate abnormality signals S1 through S7, and a notification based on any of the flow rate abnormality signals S1 through S7 may be sent to an administrator or the like. Owing to such a structure, the thermal flowmeters 100-1 through 100-7 in an embodiment according to the present invention can easily detect the flow path(s) 13, among the plurality of flow paths 13, in which the flow rate abnormality has occurred.

As described above, the thermal flowmeter 100 in an embodiment according to the present invention can heat the fluid flowing in the flow path 13 with no lopsidedness owing to the planar heating element 10 located to surround a part of the outer side surface of the flow path 13. The planar heating element 10 having the above-described structure is highly durable and has a lower risk of wire breakage or the like, and therefore allows the thermal flowmeter 100 to measure the flow rate stably. In addition, in the thermal flowmeter 100 in an embodiment according to the present invention, the planar heating element 10 can be located easily on the outer side surface of the flow path 13 by use of an existing adhesive. Therefore, the thermal flowmeter 100 can be produced by a simple production process at low cost. It is not necessary to provide a complicated structure in the flow path 13. Therefore, there is no undesirable possibility that the fluid flowing in the flow path 13 is blocked or pressure loss occurs.

As described above, the thermal flowmeter 100 in an embodiment according to the present invention realizes stable measurement of the flow rate, is highly reliable, has a simple structure, and costs low.

What is claimed is:

1. A thermal flowmeter, comprising:
a planar heating element located to surround a part of an outer side surface of a flow path;
first and second temperature detection elements located on the planar heating element at a prescribed interval; and
electrodes located at both of two ends of the planar heating element;
wherein the planar heating element contains a carbon material and cellulose fiber.

2. A thermal flowmeter according to claim 1, wherein the carbon material is carbon nanotube or carbon black.

3. A thermal flowmeter according to claim 1, wherein a flow rate of a fluid flowing in the flow path is calculated based on a signal corresponding to a temperature difference between a temperature detected by the first temperature detection element and a temperature detected by the second temperature detection element.

4. A thermal flowmeter according to claim 3, further comprising a correction circuit for correcting the signal corresponding to the temperature difference to calculate the flow rate of the fluid.

5. A thermal flowmeter according to claim 1, wherein the planar heating element is bonded to the outer side surface of the flow path by an adhesive.

6. A multi-channel thermal flowmeter, comprising:
a plurality of thermal flowmeters each including a planar heating element located to surround a part of an outer side surface of a flow path and containing a carbon material and cellulose fiber, first and second temperature detection elements located on the planar heating element at a prescribed interval, and electrodes located at both of two ends of the planar heating element; and
a plurality of abnormal flow rate detecting electronic circuits respectively connected to the plurality of thermal flowmeters, each of the plurality of abnormal flow rate detecting electronic circuits being for detecting abnormality of a flow rate of a fluid flowing in the flow path based on a signal output from the corresponding one of the plurality of thermal flowmeters.

7. A multi-channel thermal flowmeter according to claim 6, wherein the carbon material is carbon nanotube or carbon black.

8. A multi-channel thermal flowmeter according to claim 6, wherein the flow rate of the fluid flowing in each of the flow paths is calculated based on a signal corresponding to a temperature difference between a temperature detected by the first temperature detection element and a temperature detected by the second temperature detection element.

9. A multi-channel thermal flowmeter according to claim 8, further comprising a correction circuit for correcting the signal corresponding to the temperature difference to calculate the flow rate of the fluid.

10. A multi-channel thermal flowmeter according to claim 6, wherein each of the planar heating elements is bonded to the outer side surface of the flow path by an adhesive.
